(19) United States
(12) Patent Application Publication
(10) Pub. No.: US 2006/0070816 A1
(43) Pub. Date: Apr. 6, 2006

(54) Lift truck with central mast

(76) Inventor: Werner Georg Schroder, Grossostheim (DE)

Correspondence Address: Edwin D. Schindler, Five Hirsch Avenue, P.O. Box 966, Coram, NY, 11727-0966, US

(21) Appl. No.: 10/954,943

(22) Filed: Sep. 30, 2004

(51) Int. Cl. B66F 9/06

(52) U.S. Cl. 187/222

(57) ABSTRACT

A lift truck is described, which comprises a frame (8), wheels fixed thereon close to (5) and remote from the load, a lifting mechanism, a load carrier (3), which is fixed to the lifting mechanism so as to be movable and can be moved up and down by means of a free-lift cylinder (44) via a free-lift chain (47) or a band-like transmission element, possibly a staged cylinder comprising a plurality of cylinders moving telescopically one inside the other for extending and retracting any sections of the lifting mechanism present, possibly a cabin roof. The lifting mechanism has only one mast, which comprises a first section (42) or a first section and further sections (40, 41) arranged within the first section. Therein, the first section is fixed on the frame and the first and further sections are in each case made of a non-circular hollow profile (60, 61, 62), which is closed in its azimuthal direction. It is further proposed that the profiles are designed so as to be symmetrical about the centre plane, which contains the longitudinal axis of the mast and is oriented in the longitudinal direction of the lift truck.

The invention relates to a lift truck, which comprises a frame, wheels fixed thereon close to and remote from the load, a lifting mechanism, a load carrier, which is fixed to the lifting mechanism so as to be movable and can be moved up and down by means of a free-lift cylinder via a free-lift chain or a band-like transmission element, possibly a staged cylinder comprising a plurality of cylinders moving telescopically one inside the other for extending and retracting any sections of the lifting mechanism present, possibly a cabin roof

Lift trucks have proved to be general-purpose means of transport, for distribution and for warehousing and issuing goods. According to their area of use, different designs of vehicle can be used. Known construction forms include, for example
Hand fork-lift trucks
Counterbalanced lift trucks
Reach trucks
Three-sided lift trucks
Storage/retrieval machines

Hand fork-lift trucks are usually used for transportation of pallets between workplaces. Counterbalanced lift trucks are often used for the loading and unloading vehicles. Reach trucks are used for warehousing and retrieval of pallets in racks. Three-sided lift trucks are used in particular for transporting elongated goods and storage/retrieval machines are conceived especially for use in high-bay warehouses.

The outstanding characteristic of lift trucks is their high flexibility, which is expressed, for example, in a large mobility and versatility, possible use outdoors and in halls, a three-dimensional workroom, a workroom without fixed installation and the possibility of handing extremely varied goods.

For carrying out the work, the lift truck is dependent on a sufficiently large floor area, which makes available the transport routes and manoeuvring space. For the use of lift trucks in bay warehouses, the requirement means that the warehouse corridors must have a suitable width. If the load is not picked up at the side, the corridor must be wide enough for the lift truck to turn through 90° in order to pick up the goods to be stored from, or deposit them on, the shelf

Correspondingly, for example, a counterbalanced lift truck requires a corridor width of 3.50 to 4 m, a particularly manoeuvrable reach truck, on the other hand, requires a width of only approximately 2.50 m.

Since the creation and maintenance of warehouse space is very expensive, warehouse operators require industrial trucks that can manoeuvre within an extremely confined space. On the other hand, these lift trucks must be able to lift loads to great heights, and therefore require a sufficiently large base area. These partly contradictory demands have led to the development of special vehicles, which, disadvantageously, are comparatively expensive. It is also to be seen as a disadvantage that, with increasing specialisation, the flexibility necessarily decreases. For tasks outside a bay warehouse, therefore, different vehicles must often be used. For shelf operators and lift truck manufactures, this diversification results in high costs.

For industrial vehicles of the prior art, another disadvantage can be seen in the fact that the lifting mechanism for receiving the load carrier considerably restricts the view of the lift truck driver. The lifting mechanism of lift trucks is generally formed of two vertical girders and is usually fixed to the lift truck such that it assumes a position between the lift truck driver and the load. The two vertical girders thus lie, in the direction of view, on the load and therefore disadvantageously restrict sight during picking up and depositing the load. But also during travel of the lift truck with and without a load, the region in front of the lifting mechanism can only be seen with restrictions, with the disadvantageous consequence of increased risk of accident.

Against this background, it is the object of the invention to provide a lift truck that avoids the aforementioned disadvantages, has a compact and inexpensive design, and can be used versatilely. Furthermore, by means of the proposed lift truck, the variety of types necessary according to the prior art without detriment in the possibilities of use. This saves costs for lift truck manufacturers, and indirectly for the users, the lift truck according to the present invention permits the use of components of already existing industrial vehicles.

The invention provides two solutions to this object, the first being characterised in that
the lifting mechanism has only one mast, which comprises
   a first section
      or a first section and further sections arranged within the first section,
         the first section being- fixed on the frame, and
            the first and further sections being in each case made of a non-circular hollow profile, which
            is closed in its azimuthal direction,
            is preferably designed so as to be symmetrical about the centre plane, which contains the longitudinal axis of the mast and is oriented in the longitudinal direction of the lift truck,
               and the second solution in that
   the lifting mechanism has only one mast, which comprises a first section and, further sections arranged outside the first sections, wherein
      the first section
         is fixed on the frame
         and is made of a non-circular hollow profile,
            which is closed in its azimuthal direction,
      the further sections
         consist in each case of a non-circular hollow profile,
         which is designed so as to be closed in its azimuthal direction in a subregion of the section length,
      the hollow profile of the first and further sections are preferably in each case designed so as to be symmetrical about the centre plane, which contains the longitudinal axis of the mast and is oriented in the longitudinal direction of the lift truck.

According to the gist of the invention, the lifting mechanism of the two solutions is to construct the lifting mechanism of only one vertical girder, which, based on customary linguistic usage, is described below as the mast. The give design measure advantageously affects the complete design of the lift truck and its properties.

To make the mast, non-circular hollow profiles are proposed, are designed so as to be largely closed in the azimuthal direction. This design of the mast leads to a torsional stiffness, which can be easily verified on a tube with circular cross-section. If the torsion of such a tube with a profile open in the azimuthal direction is compared with that of a tube of the same diameter with a profile closed in the azimuthal direction, the, for the same torque, for the ratio V of the two torsions, the relationship:
V=⅓Δ(t/r)²,
where t=wall thickness and r=mean radius of the tube.

When numbers are substituted into this formula, a huge difference between the two stiffnesses becomes clear in a drastic manner. A value of, for example t/r=⅕ leads to a ratio of the torsions of 1:75, that is to say the torsional stiffness of the closed profile is greater by a large multiple than that of an open profile. The result of this example is generally valid and can also be applied to non-circular profiles as long as their diameters are not too different in two mutually perpendicular directions. The design of the mast in the case of the present lift truck of largely closed profiles therefore leads to a very stable lifting mechanism.

In a simple embodiment of the lift truck according to the invention, the mast only has a single section. This is fixed to the vehicle frame; in the majority of application case is rigidly connected to the frame. This lift truck is provided for tasks in which loads must be predominantly transported and in each case only lifted to a limited height, such as, for example, during loading and unloading a vehicle.

However, the invention also provides lift trucks whose masts are in each case composed of a plurality of sections. Two solutions are proposed, which differ in that, in solution one, the further section is mounted within the first section and, in solution two, are mounted outside the first section, wherein, in both cases, the first section is fixed to the frame of the lift truck. This embodiment leads to the case in which, in solution one, closed profiles can be used for all sections while, in solution two, the further sections are designed so as to be open in the region in which the first section is fixed to the frame. Other functional differences of the two solutions result for the fixing of the load carrier to the mast, which is discussed below.

According to another feature of the invention, the hollow profiles are generally designed so as to be symmetrical about the centre plane that contains the longitudinal axis of the mast and is oriented in the centre plane of the lift truck. Although this symmetry is not absolutely necessary, it is advantageous for a simpler construction of the load carrier and guiding of the sections.

As a result, the proposed design measures permit the construction of a very compact lift truck with, advantageously, a reduced number of individual parts, or components, in comparison to lift trucks of conventional design.

The saving of components leads, on one hand, to a reduction of the manufacturing costs of the lift truck, but on the other also to a reduction of its weight. The reduction in the region of the mast is particularly noticeable, that is to say in the region of the lift truck, which makes no contribution to the counterweight. The reduction of the weight therefore does not cause detriment to stability, but on the contrary advantageously leads to a reduction of the drive forces. It is to be noted that the realization of the drives is not restricted to the aforementioned hydraulic cylinder but can be performed by means of electrical linear drives.

The mast constructed from closed profiles provides the lifting mechanism with great stiffness to flexion and torsion. The profiles here can be designed such that the. mast has the same flexural strength in all directions. This advantage is particularly effective in embodiments of the present lift truck in which the loads assume changing positions, for examples in embodiments with a pivoting fork. Hollow profiles additionally have a high dimensional stability. The individual sections can therefore be made very accurately fitting, with a correspondingly small play and good guidance of the individual sections. In particular, the embodiment of the lifting mechanism by only one vertical girder leads to a considerable improvement in the vision of the truck driver and correspondingly to security and receiving and transporting the goods.

The basic designed features predestine the proposed lift truck for a modular construction and, with few changes or additional components from the standard design, permit lift trucks with in each case additional functions to be derived. Correspondingly, according to the present invention, the normal variety of types of industrial vehicles according to the prior art can be greatly restricted. This saves considerable costs for lift truck manufacturers and users.

For fixing the load carrier on the mast, the invention provides for guide rails, which are mounted on the respective outermost section of the mast on its outer surface. The guide rails extend in the longitudinal direction of the mast and are arranged so as to be symmetrical about the centre plane of the mast. The load carrier is here, in a manner known per se, equipped with guide rolls, which engage in the guide rails and thus fix the load carrier on the mast such that it can move upwards and downwards. The guide rails are, in the present invention, advantageously predetermined by the shaping of the hollow profile and are thus an integral part of the profile. This design of the guide rails leads to a very stable design of the load carrier on the mast, and has the consequence that the load carrier and its components are very readily accessible from all sides and correspondingly simple to maintain.

For the fixing of the mast to the vehicle frame, in principle, a plurality of constructional solutions are possible. Correspondingly, with a simple embodiment of the lift truck according to the invention, the mast is rigidly connected to the frame, in contrast to which preferred embodiments provide for a pivotable fixing of the first section to the frame. In the latter embodiment, the lower pivot point in the region of the mast base, and upper one in a region of the first section that extends approximately to the height that includes, or would include, the edge of an existing cabin roof, if present. The articulated section is here designed so as to be pivotable in one of the articulation points about a horizontal axis lying perpendicular to the longitudinal vehicle direction. The pivoting itself is carried out by means of a drive arranged between the other articulation point and the frame, which usually will be a hydraulic tilt cylinder. Electric linear drives are attractive advantages.

The proposed embodiment of the articulation points alternatively permits a pivoting of the mast about the lower articulation point and a pivoting about the upper articulation point. Of special interest for the further embodiment of the proposed lift truck is a pivoting of the mast about a fulcrum located above the mast base. A plurality of the further embodiments of the proposed lift truck presented in the description provide for an articulation of this kind.

For purposes of ergonomy, it is of advantage if relevant articulation points of the first section are equipped with means that prevent a transmission of sound and/or vibrations. As means with these properties, rubber bearings have proved suitable. The present invention provides for such means, preferably on an articulation point of the first section, about which the pivoting of the mast and on the fixing point of the tilt cylinder to the frame. By means of this constructional measure, a transmission of the vibrations caused by movements of the mast sections and of the load carrier to the lift truck drive is largely prevented. The advantageous consequences of this are improved working conditions on the lift truck; in particular, this measure permits less working fatigue.

The design of the mast as a single vertical girder permits a very advantageous attachment of the mast to the frame of the lift truck. According to a feature of the invention, it is provided that the mast is arranged in the longitudinal direction of the lift truck between the wheels close to and remote from the load. By this means, the proposed embodiment of the mast permits a position of the mast that is displaced further towards the centre of the lift truck in comparison to conventional lift trucks. The advantageous consequence of this is a smaller front dimension, and therefore a shorter vehicle length. The shorter overall length leads in turn to greater manipulability, and therefore smaller manoeuvring space for the lift truck. This advantage is particularly effective for deployment of the proposed industrial vehicle in bay warehouses. It permits a further reduction of the corridor width and saving of expensive warehouse space.

The same aim, of reducing the overall length of the lift truck, is also served by an embodiment of the lift truck with a special arrangement of the wheels close to the load. According to a feature of the invention, it is provided to make the track width of the wheels close to the load greater than the narrow side of a euro-pallet and greater than the width of the load carrier in the direction transverse to the longitudinal direction of the lift truck. This embodiment ensures that the load carrier can drive into the space between the wheels close to the load and pick up or deposit loads. The proposed embodiment thus supports an arrangement of the mast that is displaced as far as possible towards the vehicle centre.

The arrangement and design of the wheels close to the load is particularly important in the present invention. In a preferred embodiment of the lift truck according to the invention, the frame of the vehicle has a frame part that is displaceable in the longitudinal direction of the lift truck, on which the wheels close to the load are fixed. Based on the nomenclature conventional for lift trucks of the prior art, a displaceable mast will henceforth be given the designation thrust axis. The displacement of the thrust axis preferably takes place by hydraulic means, in the present case by a thrust-axis cylinder hinged between the frame and aforementioned frame part.

In a preferred technical implementation of the thrust axis, it is provided that the aforementioned frame part has at its rear end on both sides, in each case a first roller, which lie on a horizontal axis oriented perpendicularly to the vehicle's longitudinal direction, and in each case engage in rails which are mounted on both sides of the frame and face in the longitudinal direction of the lift truck. At the front end of the frame part, one rail in each case is also mounted on both sides, and faces in the longitudinal direction of the lift truck. Into these rails, rollers engage, which are fixed on a traverse of the mast, which is fixed in the region of the aforementioned bottom articulation point of the first section of the mast, and has an orientation parallel to the pivot axis of the mast.

The proposed constructional measures lead to the mast and the thrust axis supporting one another and—in an advantageous manner—are movable with respect to one another. According to a feature of the invention it is in particular provided for the displacement of the thrust axis in the longitudinal direction of the vehicle and the pivoting of the mast about its horizontal pivot axis to take place simultaneously or independently of one another. Of particular interest here is a displacement of the axis and pivoting of the mast synchronously with one another without simultaneous pivoting of the mast. Both alternative sequences are used to increase the stability of the lift truck. They are advantageously used in lift-truck embodiments in which the track width of the wheels close to the load is smaller than the load or load-carrier width.

The last-mentioned alternative sequence, in such a lift truck, allows the wheels close to the load, after lifting of the load above the wheel height, to be pushed through forwards beneath the load, and shortly before lowering of the load below the height of the wheels, to be retracted again, the operation taking place manually or automatically. The position of the mast bas in the operation remains unchanged; the mast therefore retains its give tilt. The displacement of the thrust axis is carried out by means of the shear-axis cylinder.

Since, in the above-described operation, the distance between the centre of gravity of the load and the tilting point of the lift truck, which corresponds to the point of contact of the wheels close to the load on the ground, is reduced, the stability is correspondingly increased. For example, in the case of the present lift truck, with a forward displacement of the thrust axis by, for example, 250 mm, the stability is increased to a value greater than or equal to 2. After lifting of the load beyond the wheel height, the lift truck thus has a high stability, which ensures adequate stability both during transport and during storage.

According to a feature of the invention, it is also provided that the displacement of the thrust axis in the above-described form takes place in each case automatically, as soon as the load carrier is raised beyond the height of the wheels close to the load, or before it is lowered below the height of wheels.

During stacking at great height, in a lift truck according to the present invention, an additional contribution to stability can be achieved by a suitable coordination of the operations. According to this, the load is first inserted into the bay until the load wheels of the lift truck bump against shelf rack. Subsequently, the lift-truck driver steps on the vehicle brake and at the same time activates a retraction of the thrust axis. This operation, because the vehicle brake is in action, leads to the load wheels maintaining their geometrical position, while the vehicle moves in the direction of the load wheels. The counterweight of the lift truck thus generates the maximum possible counter-torque at every point in time during this operation, and provides the stacker with optimum stability.

In the first alternative sequence, in which the displacement of the axis and the pivoting of the mast take place synchronously with one another, the tilting cylinder and thrust axis cylinder come into action simultaneously. During this, the movements of both cylinders are controlled such that the position of the thrust axis and the tilting of the mast change continuously, while the position of the mast base remains unchanged relative to the thrust axis. This function is used in particular for extremely short lift trucks, whose wheels close to the load have a track width smaller than the load or load-carrier width. If, in such a lift truck, the static stability during raising of the load is only slightly greater than 1—which means that the torque of the load and that of the counterweight are virtually equal, the lift truck is therefore in a state close to tilting over the wheels close to the load—the stability can be restored by synchronous changing the thrust-axis position and the tilting of the mast immediately after raising the load. An axial advance with simultaneous advance of the mast base by only approximately 150 mm leads, in the case of the present lift truck, to an increase in stability to the value of 1.4, which ensures reliable lifting of the load. In particular with the transport of loads, it is recommended to tilt the mast towards the vehicle, since this increases the stability during travel. After raising of the load beyond the height of the wheels close to the load, the thrust axis can additionally come into action, as described above.

If a thrust-axis lift truck according to the present invention is compared with a thrust-mast lift truck familiar in the prior art and designed for use in very confined space, several advantages can be seen for the embodiment according to the invention. For the same load-bearing capacity, the thrust-axis lift truck according to the invention has small dimensions, and is therefore superior to the thrust-mast lift truck in its manoeuvrability. In addition to a displacement of the axis, with the present embodiment, a tilting of the mast is also possible, which can also be used for increasing the stability. The visibility conditions in the region of the mast are much better with the proposed solution, in comparison to a shear mast of conventional design, and it is therefore associated with a reduced accident risk. Because of the aforementioned features, the lift truck according to the invention can be used versatilely. Finally, manufacture of the thrust-axis lift truck is also comparatively economical, since it can be derived from a standard lift truck by means of a few additional constructional measures.

Regarding the first alternative sequence, with a displacement of the shear axis and a pivoting of the mast taking place synchronously therewith, the invention also provides for an advantageous constructional measure, which with relatively simple means, achieves the same effect. According to this it is provided that the wheels close to the mast are fixed in the region of its base. A pivoting of the mast therefore simultaneously leads to a pivoting of the wheels close to the load towards or away from the load. The effect thereby achieved is the same as for the above-described synchronous movement of the shear axis and mast. The technical effort for the present solution, which is described below by the name “pivot axis”, is, however, advantageously smaller. In order, for a given tilting of the mast, to obtain a greatest possible displacement of the load wheels fixed to the mast, it is recommended to locate the upper articulation point of the mast as high as possible on the frame of the lift truck.

In the last-mentioned embodiment of the lift truck according to the invention with a tiltable mast, a particularly advantageous arrangement of the drive units is available. In this embodiment, the invention provides a drive of the wheels close to the load in which the drive units are arranged in the space between the wheels and mast base. By virtue of the design of the mast as a vertical girder, and its arrangement for example in the vehicle centre before the driver's cabin, space becomes free between the wheels and the mast, which in conventional lift trucks is taken up by the two vertical girders of the lifting mechanism. In the present invention, this space is used to accommodate the axial and drive units, a use, in the longitudinal direction of the vehicle, so close to the load carrier being possible, that only a necessary safety clearance between the load carrier and drive units remains. The advantageous consequence of this arrangement is an extremely short design for the embodiment of the lift truck according to the invention as a counterbalance lift truck. It goes without saying that the proposed arrangement cannot only be used for lift trucks with a pivot axis, but also for embodiments with a fixed mast.

Important considerations underlying the invention concern the design of the mast. According to a feature of the invention, it is provided that the first and further sections run telescopically with respect to one another, the first further section running on/in the first section, the next further section in each case running on/in the respective preceding further section, and the last further section running on/in the penultimate further section. Since the profiles used for production of the sections are characterised by high dimensional stability and deformation resistance, the telescopically arranged sections show low-play and track-precise guidance with respect to one another. A special advantage of the telescopic arrangement of the individual sections can also be seen in the fact that the respective inner sections are in each case protected by the respective outer section. The cavities in the individual sections are moreover predestined for receiving components and assemblies for controlling the movements of the mast and the load carrier. The arrangement within the hollow profile also advantageously provides these components with high protection against mechanical destruction.

An important point for aesthetes is also the appearance of the lift truck according to the invention. Through the design of the mast as a closed, predominantly smooth body, the lift truck gives a very attractive visual impression.

The telescopic arrangement of the individual sections requires specially formed hollow profiles. For the production of the sections, in the scope of the present invention, there are, in particular two ways. Firstly, profiles are provided that consist of a one-part profile, and secondly there are those that are welded together from individual rolled profiles. Hereby, for production in large quantities, the one-part profile is to be preferred for the manufacture of a multiplicity of series that differ from one another. And the aforementioned method also offers greater flexibility for constructional improvements of the mast made in the course of technical progress. In the case of welded profiles, it is recommended that the innermost-lying section be manufactured from two rolled profiles of mirror symmetrical design. The outermost-lying sections, on the other hand, can be more easily manufactured if one rolled profile in each case is provided for each of the side mast regions, which are connected to a transverse metal plate, in each case, arranged respectively in and opposite to the direction of travel.

The closed hollow profiles, even at comparatively small diameters, already have adequate torsional and flexural stiffness for use as the lift-truck mast. To exploit this advantage, sophisticated profile shapes are required, and since, in addition to a telescopic arrangement, the mast is also required to accommodate a multiplicity of components in its interior. According to a feature of the invention, it is therefore provided that, in the case of two sections that are adjacent in the radial direction, the respective innermost of the sections has on its outside, and/or, the respective outermost section has on its inside, in each case, guide rails, in the longitudinal direction of the mast and symmetrical about the centre plane of the mast, for guiding the sections. In these rails there engage one or more guide rollers, which are attached at the respective other section, in order to accomplish the guidance of the sections. This design permits, on one hand, a precise guidance of the individual sections with respect to one another, but on the other hand advantageously takes up a comparatively small space.

The design of the mast, comprising a plurality of sections, inevitably leads to the individual sections, during extension of the mast, in each case running against a stop. To allow this operation to take place more gently for the material and the lift-truck driver, in an embodiment of the present invention, it is provided that the further sections, when they reach the fully extended and fully retracted position each case run against an end-position damper.

Another embodiment takes into account the most efficient possible maintenance of the mast and its components arranged in the interior. In this embodiment, the further sections are designed so as to be extensible in the direction facing the mast base. They can therefore be removed downwards from the first mast section for maintenance and repair as required. The components, which are optimally enclosed during operation, are then completely open and freely accessible for maintenance, so that the repair work, where necessary, can be carried out very efficiently. In this manner, in particular the rollers for guiding the individual sections can be easily exchanged in the event of servicing.

Important considerations regarding the present invention also concern the design of the interior cavities of the hollow profiles. According to these considerations, the hollow profile of the innermost section is designed such that it has at least one cavity extending over the length of the section. This is provided for receiving components for executing the upward and downward movement of the load carrier. In the case of variants with two cavities, it is proposed to use the cavity facing the load preferably to receive the staged cylinder and the cavity facing away from the load preferably to accommodate the free-lift cylinder. The staged cylinder, then, has the task of extending and retracting the individual sections, whereas the free-lift cylinder controls the movements of the load carrier.

From the proposed design of the cavities, there result advantageous solutions for the hydraulic cylinder, in particular together with a further feature of the invention. According to this feature, one of the aforementioned cavities is designed as a cylinder of a hydraulic piston-cylinder arrangement. The use of this cavity as the last or first of the cylinders, running telescopically one inside the other, of the staged cylinder is preferred. In the aforementioned embodiment with two cavities, this means that the cavity facing the load performs this function. Here, it is not essential that this cavity has a circular cross-section, since the rest of the cylinders, running one inside the other, of the staged cylinder may conversely be equipped with a cross-section that corresponds to that determined by the cavity. The simultaneous utilisation of a cavity as a cylinder of a hydraulic piston-cylinder arrangement provides the advantage of weight saving and advantageously also leads to a reduction of the individual parts and therefore other costs for the staged cylinder.

The further embodiment and arrangement of the hydraulic cylinder is given by the features mentioned in a plurality of sub-claims. In particular, these claims concern the hydraulic linking of the staged cylinder and free-lift cylinder.

In a preferred embodiment, it is correspondingly provided to connect the staged cylinder and the free-lift cylinder hydraulically in series. The sequences during extension of the sections and lifting the load carrier are advantageously supported by this embodiment. If the phase of lifting the load within the first section is first considered, then the given embodiment leads, as hydraulic oil is introduced into the cylinder, to the piston of the free-lift cylinder extending and, via this, to the free lift chain of the load carrier that is attached to said piston being lifted. As the load carrier reaches the stop at the end of the first section, however, the further movement of the free-lift chain, and therefore of the piston of the free-lift cylinder is blocked off. Further introduction of hydraulic oil then leads to an extension of the staged cylinder, and therefore of the respective next section, out of the previous section. An advantage of the series connection of both cylinders is that, by this means, the connection, which would otherwise be necessary, of the aforementioned cylinders to the respective associated hydraulic lines is eliminated.

For the technical implementation of the series circuit, it is provided according to the present invention that the first cylinder of the staged cylinder is fixed at the first section and is terminated in the region of the mast base by means of a cylinder bottom, while the last cylinder of the staged cylinder is fixed to the last further section and is terminated in the region of the upper end of this section by a cylinder bottom. By this means, the supply of the hydraulic oil into the staged cylinders takes place through an opening in the cylinder bottom of the first cylinder and the transfer of the hydraulic oil to the free-lift cylinder takes place through an opening in the cylinder bottom of the last cylinder.

In a similar manner, the cylinder of the free-lift cylinder is fixed on the last further section and is terminated by a cylinder bottom in the region of the upper end of this section, the piston of the free-lift cylinder facing downwards. The feeding of the hydraulic oil to the free-lift cylinder takes place through an opening in the cylinder bottom of the cylinder of the free-lift cylinder.

In the proposed arrangement of the stages cylinder and free-lift cylinder, the series connection of the two cylinders can be produced simply by connecting the openings, which lie at the same level, in the cylinder bottom of the free-lift cylinder and of the staged cylinder by means of a hydraulic line. Another preferred solution for the series connection of the two cylinders according to the present invention provides that the two aforementioned cylinder bottoms are fixed to a common element, and a channel is formed in the element, which connections the openings in the two cylinder bottoms to one another.

The staged cylinder and free-lift cylinder are, in the preferred embodiment of the hollow profile of the innermost section with two chambers, in each case accommodated in one of these cavities. The cavity for the free-lift cylinder, in the present invention, also incorporates parts of the free-lift chain. According to the invention, it is provided that the one end of the free-lift chain is fixed on the interior wall of the last further section, on the downwardly facing end of the piston of the free-lift cylinder, a first deflection element, and above the aforementioned element, for fixing the cylinder bottom, a second deflection element is provided, over which the free-lift chain is guided. The free-lift accordingly runs from the fixing point on the innermost section, over the deflection element on the piston of the free-lift cylinder, and from there to the second deflection element above the cylinder bottoms of the free-lift cylinder and staged cylinder. In this region, it emerges from the aforementioned section and is finally fixed at its other end to the load carrier. The proposed guidance of the free-lift chain, on one hand, presents an absolutely functionable solution, on the other hand in an extremely small space, the chain, because of the arrangement in the interior of a section, is advantageously largely protected against external damaging mechanical effects.

In the lift truck according to the present invention, the hydraulic hoses for supplying the load carrier with compressed oil in the region of the aforementioned second deflection element directly above the free-lift chain are guided transversely through the mast. Correspondingly, it is proposed to provide within the mast a further deflection element for guiding the hydraulic hoses. The hoses thus enter the mast, coming from a hose drum, at the rear side of the mast, and leave the mast at its opposite side, together with the free-lift chain. From there, they follow the free-lift chain as far as the load carrier.

The design of the mast from individual section permits a one-part and multi-part mast. Within the scope of the present invention, a one-part mast and one comprising three sections is preferred. The three-part mast correspondingly has an outer section, a mid-section and an inner section, preferably the outer section being fixed and the inner section being extensible. The proposed three-part mast permitting storage and retrieval up to a height of 10-12 metres, and thereby meets the requirements for use in high bays.

In a special embodiment of the lift truck according to the present invention with a multi-part mast, it is provided to design the overall height of the mast, with the sections retracted, lower than the eye level of the lift-truck driver. The number of sections in the case of this lift truck is usually greater than three. With, for example, 4 sections, a storage and retrieval height of approximately 4.5 metres can be realised. The advantage of this embodiment lies in the unobstructed vision, which gives the lift-truck driver an all-round view. The aspect of safety is thus taken into count in an optimum manner by the present embodiment.

In the aforementioned embodiment, there is occasionally the need to build up the mast with further sections. The invention provides for such possibilities in principal. In particular, according to a feature of the invention, it is provided that the staged cylinder can be extended by at least one further cylinder. In this case, a further cylinder with a diameter connected to the diameter of the last provided cylinder is placed against the latter.

The design of the mast comprising sections, running telescopically one inside the other, with different outer diameters requires special solutions for executing the upward and downward movement of the last carrier on the mast. In designs of the mast with a fixed outer section and movable inner sections, the solution provides that the load carrier, for upward movement, runs in the guide rails of the outer section as far as the upper end of this section. After reaching this position, it is coupled to the inner section by special devices and locked to it. The further upward movement is then executed by the load carrier together with the inner section.

The solution in the drawing comprises a plurality of constructional measures which are briefly described below.

These measures include a striker plate, which is fixed at the upper end of the last further section, and against which the load carrier strikes in case the lift height exceeds the length of the first section. It is of advantage here if the load carrier, when striking against the striker plate, strikes against an end-position damper. The primary function of this striker plate consists in, during an upward movement of the load carrier, preventing the latter from running out of its guide rails mounted on the outermost section. The striker plate, however, also has other functions, which are described in following sections.

The aforementioned constructional measures further comprise means for frictional locking of the load carrier to the last further section, which are provided on the upper end of the last further section and/or on the load carrier. These means, after arrival of the load carrier at the upper end of its guide rails, preferably after striking of the load carrier against the striker plate, effect a coupling of the load carrier to the innermost section.

In a preferred embodiment of the lift truck according to the invention, these means for coupling comprise receptacles in the striker plate, in which counter-receptacles provided on the load carrier engage in an interlocking manner. By means of this embodiment, in an advantageous manner, simultaneously with the striking of the load carrier against the striker plate, a coupling of the load carrier to the innermost section is executed.

A further advantageous embodiment is characterised by the fact that the aforementioned means for coupling guide elements, which are mounted at the upper end of the last further section, grip over the load carrier externally, and thereby support it. This measure is provided for additional stabilisation of the load carrier after it has been coupled to the innermost section. The technical implementation of the aforementioned guide elements permits a plurality of solutions; in the scope of the present invention, an embodiment with rollers is preferred.

Alternatively or additionally to the proposed coupling of the load carrier by means of interlocking engagement of receptacles and counter-receptacles, the invention provides an especially preferred solution. This is characterised in that the innermost section in a retracted state projects with its top end from the other inner sections, and the first section, and further guide rails for guiding the load carrier are attached. These rails have, in each case, the same cross-section as the guide rails for guiding the load carrier at the first section, and are arranged such that they are aligned with the aforementioned guide rails on the first section.

In this embodiment, the transition of the load carrier from the first section to the innermost section can be carried out especially without problems. During upward travel, the load carrier simply makes a transition from the rails of the first section to the same shaped rails at the topmost end of the innermost section. During downward travel of the load carrier, the same operations take place in reverse sequence.

The preferences of the last-mentioned embodiment are also obtained with the initially explained second solution to the lift-truck according to the invention, in which the mast has a first section fixed on the frame and further sections arranged outside the first sections. In this embodiment, the outward sections are extended. Since the outermost section has the guide rails for receiving the load carrier, in the case of a lift height beyond the level of the first section, no transfer of the load carrier is necessary. The load carrier rather executes these movements together with the first section. The disadvantage of this solution however is that the walls of the outward sections intersect the fixing point of the first section on the frame. The profile of the outer sections cannot therefore be designed so as to be closed in the region that slides over the articulation points of the first section during retraction and extension of the sections. By this means, disadvantageously, part of the torsional and flexural stiffness of the complete mast is lost. Nevertheless, this mast has a better structure than the lifting mechanisms made of two vertical girders according to the prior art. In the scope of the present invention, however, a design of the mast according to solution one, with an outer section fixed on the frame and extensible inner sections is preferred.

The coupling of the load carrier to the striker plate or the last of the further sections is associated with rapid changes in velocity of the drive elements involved. The last carrier first, driven by the free-lift chain, travels up the first section. With the striking against and coupling the load carrier on the striker plate, however, the velocity of the free-lift chain is not returned to zero. Since the subsequent lifting movement of the load carrier takes place by means of an extension of the sections, after the coupling operation, the staged cylinder must be activated. Correspondingly, its extension velocity is raised from zero to the value determined by the lifting velocity.

According to the invention, measures are provided for allowing the aforementioned operations to take place as gently as possible. These measures comprise, firstly, the aforementioned series connection of the free-lift cylinder and staged cylinder. On the other hand, they provide for the piston of the free-lift cylinder, on charging of the two aforementioned cylinders with pressurised oil in the position determined by the highest-possible position of the load carrier on the first section, runs against a stop formed on the first section. The two measures together lead, with continuing charging of the staged and free-lift cylinders, the cylinder of the free-lift cylinder moves relative to the fixed free-lift piston, and thereby the innermost section, which is fixed to the cylinder bottom, rises. With the lifting of the innermost section, however, the staged cylinder, whose one bank (sic) is also fixed on the innermost section, is forced to change length. The simultaneous increase of the hydraulic volume enclosed by the free-lift cylinder and by the staged cylinder leads to the lifting velocity of the innermost section being only half as big as for exclusive charging of the staged cylinder with the same volume flow rate. The process described is limited to a few centimetres of the innermost section relative to the outermost during the coupling operation, and has the advantageous effect that this process takes place comparatively gently.

The aforementioned means for coupling the load carrier to the innermost section largely encompass means for locking the load carrier and innermost section. In the case of a preferred embodiment of the lift truck according to the invention, at least one locking level is provided, which is fixed in the region of the upper end of the innermost section, and fulfils different functions depending on its position. With a movement of the load carrier on the guide rails of the first and possibly the innermost section that are assigned to it, the lever assumes a first position, which releases the path of the load carrier as far as the striker plate. After beginning the upward movement of the innermost section, it changes to a second position, which locks the load carrier against a downward movement. With a downward movement of the load carrier, finally, the locking lever, after almost complete or complete retraction of the innermost section, changes from the second position back to the first position and releases the load carrier again for movement on the guide rails assigned to it.

In a preferred embodiment of the present lift truck, it is provided that the transition from the first position of the locking lever into its second position is controlled by the movement of the load carrier relative to the first section. Correspondingly, a stop is formed on the first section, against which the lever bears in its first position. With an upward movement of the load carrier, after striking of the load carrier on the striker plate, the innermost section together with the locking lever is raised, while the aforementioned stop remains stationary against the first section. By this means, the locking lever of the stop is withdrawn, so that, driven by the spring force, it changes to its second position.

The locking lever ensures that—for a lift height of the load carrier going beyond the height of the first section—the load carrier is firmly connected to the innermost section. As already mentioned, movements of the load carrier at heights lying above the first section are performed by retraction and extension of the sections. During these movement operations, the free-lift chain is tightened such that the load carrier is pressed against the striker plate by means of the free-lift chain. The load carrier is therefore held during upward and downward movements above the first section, by both the locking lever(s) and the free-lift chain. The double safeguarding of the load carrier ensures an absolutely secure operation of the lift truck at lift heights above the height of the first section.

In addition to the redundant fixing of the load carrier at the upper end of the innermost section the present invention also provides for a catch device, which in the even of incorrect fixing of the load carrier, prevents extension of all inner sections. In a preferred embodiment of the lift truck according to the present invention, the catch device cooperates with the locking lever. The device has in this case, in addition to the aforementioned lever, a bolt attached on the first section, which, with a certain distance, faces a stop mounted on the locking lever. During extension of the innermost section when the locking lever is set to the first position, i.e. at which the setting of the locking lever is in the first position, i.e. the position at which the load carrier was not locked, the stop of the lever runs against the bolt of the first section and thereby blocks a further extension of the innermost section relative to the first. The fault-free transfer of the load carrier from the first section to the inner section is thus a prerequisite for extension of the inner sections.

The aforementioned distance between the bolt and stop fulfils, according to the invention, a special function. It is of the order of several centimetres and permits a movement of the outermost and innermost sections relative to one another of this order of magnitude. This movement is necessary, since the processes that lead to a transfer of the load carrier to the innermost section, and to locking of the load carrier take place within a finite time span. By virtue of the distance between the bolt and the stop, this time span is made available for correct operation, since the catch device would only grasp the innermost section by the aforementioned distance.

The present invention, in addition to lift trucks, comprises all other industrial vehicles equipped with a mast. This includes, for example storage/retrieval machines, high-level pickers or order-picking trucks. The first-mentioned vehicles are characterised by the fact that they operate without driver, which in the case of the last-mentioned, the driver's cabin can move up and down, together with the load carrier, on the mast.

invention allows free scope for designing the arrangement of the driver's cabin in the case of high-level pickers. A solution is preferred in which the picking platform is arranged around the mast, an essentially symmetrical arrangement being advantageous for reasons of stability. In the work of the picker at large heights, the height flexural and torsional stiffness is of advantage, since it leads to smaller fluctuations for the picking platform than for conventionally designed high-level pickers. The same effect is achieved by the smaller play between the individual sections of the mast compared with picking trucks of the prior art. Because of the particular suitability of the lift truck according to the invention for modular construction, for the manufacture of high-level pickers, existing lift truck types according to the present invention can be used as basis.

The present invention also allows particularly advantageous solutions as regards the design of the driver's cabin and the driver's seat. By means of the design according to the invention of the mast as a vertical girder, and its arrangement approximately in the vehicle centre in front of the driver's cabin, space is made free to the right and left of the mast, which in the case of conventional lift trucks is taken up by the two vertical girders of the lifting mechanism. By using this space as foot space, the overall length of the lift truck can be reduced, with the advantageous result of better manoeuvrability of the lift truck with respect to lift trucks of conventional design.

For the arrangement of the seat, the invention provides a plurality of advantageous variants. In a first, the driver's seat is arranged centrally behind the mast and the space to the right and left of the mast, in the region of its base, is used as foot space for the driver. A second variant has a driver's seat that is arranged offset sidewards relative to the mast, the space at the side of the mast being used as foot space for the lift-truck driver. Also provided according to the invention is an embodiment in which the driver's seat is oriented crosswise to the travel direction. The seats in the aforementioned arrangement can be designed either as fixed seats or as rotating seats. Finally, an embodiment of the driver's seat as a standing work place is provided. With all embodiments, an extremely short overall size of the lift truck is of advantage.

The industrial vehicles according to the present invention can be equipped with all familiar drive sources. Of interest here are diesel or gas operated vehicles, and in particular battery operated.

In the case of battery-driven vehicles, the design of the battery compartment is particularly important. According to a feature of the invention, it is provided that the compartment for receiving the battery is accessible from the side of the lift truck. However, this design has wide-ranging consequences for the structural stability of the lift truck.

In the case of lift trucks of conventional design, the battery is inserted and removed from above using lift-out equipment and a hoist. The frame is correspondingly designed so as to be open at the top, while the side walls of the battery compartment are formed by sturdy metal plates. In this embodiment, the sidewalls of the battery compartment perform important structural supporting functions. For an exchange of the battery upwards, however, the driver's protective roof assumes a very unfavourable position. To allow the exchange to be carried out, the driver's roof is therefore designed in many lift trucks such that it can be swung aside, or in other embodiments has at least recesses or slots, through which the lift-out equipment can be guided. Overall, a battery exchange by the described process is complicated and time consuming, furthermore, the protecting or cabin roof is considerably weakened, or its design is comparatively expensive.

For battery exchange from the side of the lift truck, as proposed by the present invention, the changing process is considerably simplified. The battery is only inserted into or removed from the compartment from the side by means of a lift truck. To further facilitate this process, according to a feature of the invention, it is provided to provide the battery compartment at the upward and/or forward and/or backward facing edge with a lead-in chamfer, for example an angled edge—without major disturbance even during a shift. Lift trucks according to the present invention can therefore be equipped with smaller batteries than normal. This measure again advantageously benefits the overall length of the lift truck, which thereby can also be shortened. An additional advantage of the sideways battery exchange can also be seen in the fact that the design of the driver's protection roof or cabin roof is not restricted by the battery exchange.

With opening of the battery compartment at the side, the elimination of one side wall at the same time removes an essential structural element of the conventional frame structure. The aforementioned element serves in particular for receiving thrust forces; its elimination therefore leads to a weakening of the frame. To compensate for the reduced stiffness of the frame, with the present invention, a U-profile metal plate lying outside the battery compartment is provided, which reinforces the upward and/or forward and/or backward facing walls of the battery compartment. The aforementioned U-profile sheets give the frame, firstly, the necessary stiffness; secondly, they can also be advantageously used as ducting for leads and hoses. The design of the protective roof in the present solution is, of course, free of restrictions caused by the battery exchange and can correspondingly have a simple design.

Irrespective of side access to the battery compartment, the arrangement of the counterweight should be carried out. According to the present invention, it is provided to arrange the counterweight in the rear region of the battery compartment or in the region rearwardly contiguous to the battery compartment.

Further details, features and advantages can be taken from the subsequent part of the description, wherein exemplary embodiments and details of the lift truck according to the invention are explained with reference to a drawing, wherein

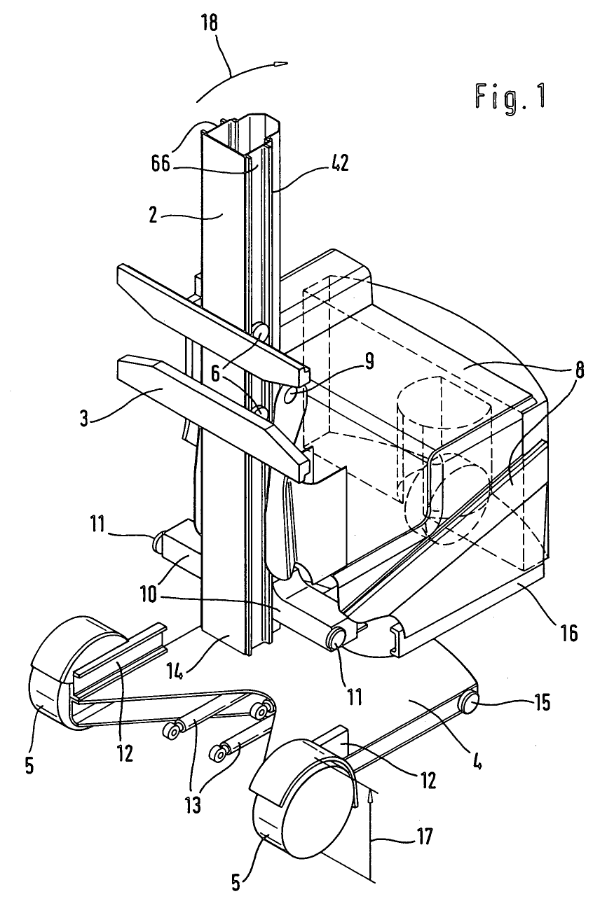

FIG. 1 shows a lift truck with thrust axis

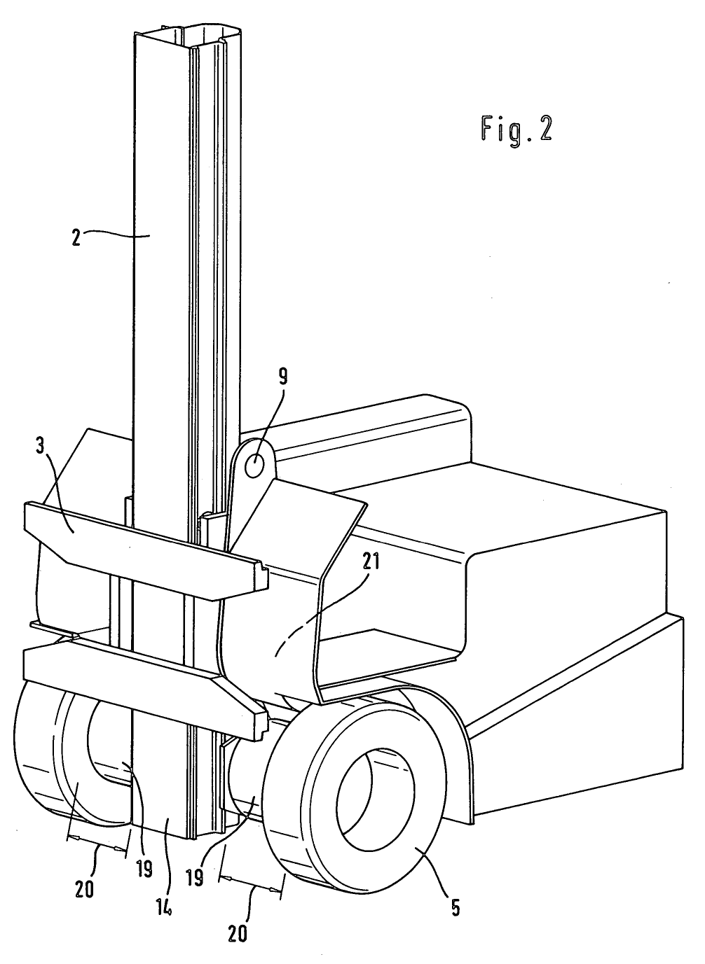

FIG. 2 shows a lift truck with pivot axis

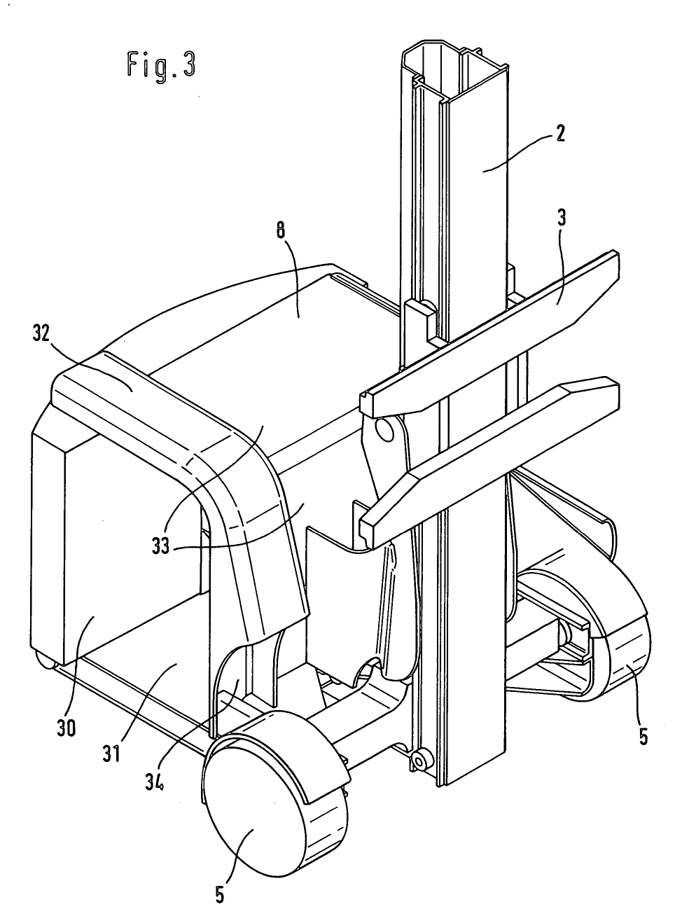

FIG. 3 shows a battery compartment of a thrust-mast lift truck

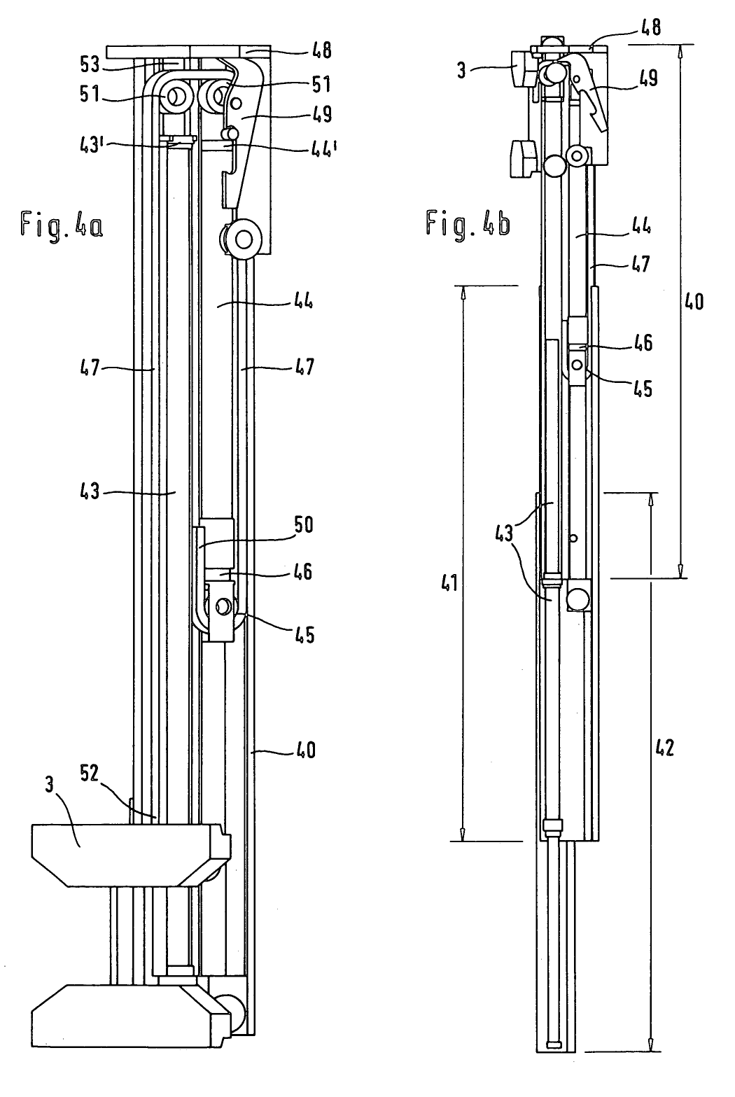

FIG. 4a shows essential components of the interior section of the three-part mast according to FIG. 4b

FIG. 4b shows essential components of a three-part mast

FIG. 5 shows a hollow profile of the mast sections

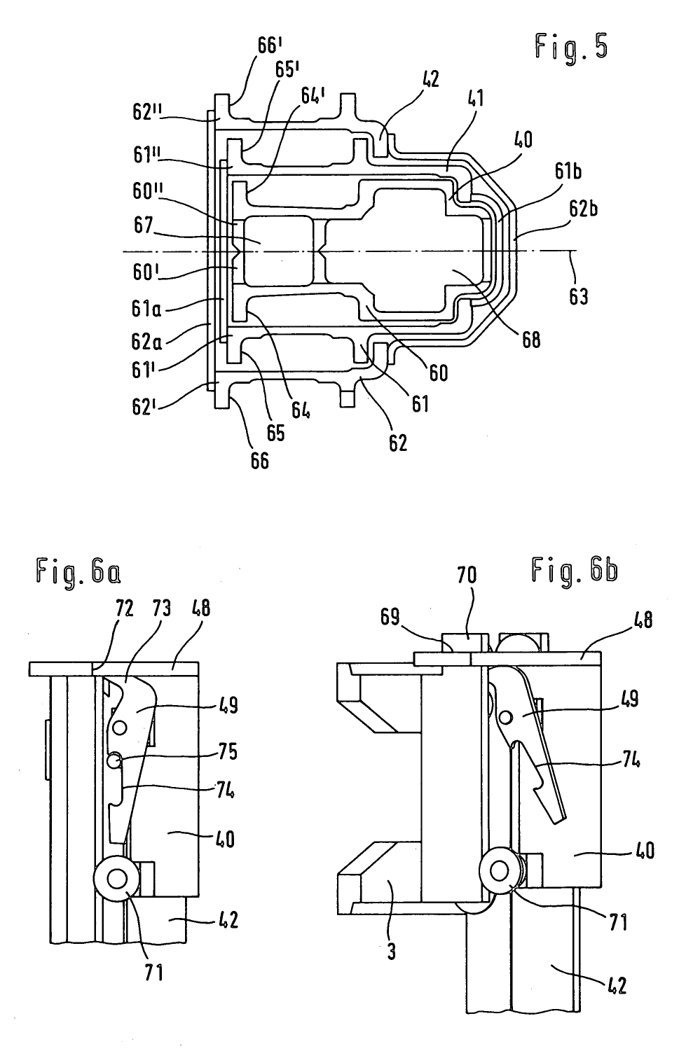

FIG. 6a shows the op end of the inner section before coupling the load carrier

FIG. 6b shows the upper of the inner section after coupling the load carrier

FIG. 1 shows the important components of a lift truck with shear axis, the shear axis being shown at a certain distance from the frame. It shows the first section 42 of the mast 2, the load carrier 3, and the thrust axis 4 with the wheels 5 close to the load. The fixing of the load carrier on the mast is carried out by rollers 6, which run in vertical guide rails 66, 66′ of the mast 2. The mast is fixed on the frame 8 of the lift truck in the articulation point 9 about a horizontal perpendicular to the vehicle longitudinal direction, while its lower end is supported, via the traverse 10 and the rollers 11, which are mounted on the end thereof, in the rails 12 of the thrust axis 4. For the sake of clarity, the rollers 11 and the rails 12 are spatially separate from one another. The reference character 13 characterises the tilt cylinders which are connected to the base 14 of the mast 2. The thrust axis 4 also has, at its rear end, on both sides, rollers 15, which come into engagement in rails 16 of the frame 8. The thrust axis can be moved by a thrust axis cylinder (not shown) in the longitudinal axis of the vehicle.

With pure displacement of the thrust axis, the rollers 15 of the thrust axis move in the rails 16 of the frame and the rollers 11 of the traverse in the rails 12 of the thrust axis, while the mast 2 remain unpivoted at the same time. For pure pivoting of the mast 2, on the other hand, only the rollers 11 of the traverse run in rails 12 of the shear axis, the shear axis 4, during this, retains its current position unchanged. In the present embodiment, a displacement of the thrust axis 4, with and without simultaneous pivoting of the mast 2 about its horizontal pivot axis, can be carried out.

The displacement of the thrust axis 4 is used to extend the wheel base of vehicle, and thereby increase the stability of the lift truck. Therefore the wheels 5 close to the load, after lifting of the load above the wheel height, are pushed forward under the load, and conversely retracted again briefly before the lowering of the load below the height 17 of the wheels 5, it being possible to carry out the process manually or automatically.

The same goal, of increasing the stability, is also served by a pivoting of the mast 2 in the rearward direction 8 accompanying the displacement of the thrust axis 4. During this the thrust axis cylinder (not shown) and the tilt cylinder 13 are controlled such that the position of the thrust axis 4 and the inclination of the mast 2 change continuously, while the position of the mast base 14 relative to the thrust axis 4 remains unchanged. As a result, by virtue of the inclination of the mast 2, the load centre of gravity is additionally displaced towards the vehicle centre and the stability is thereby further increased.

FIG. 2 shows an embodiment of the lift truck with a pivot axis, in which the effect which can be obtained by a displacement of the thrust axis and a pivoting of the mast, taking place synchronously therewith, is achieved by other constructional measures. These measures provide for a direct fixing of the wheels 5 close to the load to the mast 2 in the region of its base 14. A pivoting of the mast 2 about the pivot axis 9 therefore leads simultaneously to a pivoting of the mast 2 about the pivot axis 9 therefore simultaneously leads to a pivoting of the wheels 5 close to the load towards the load or away from the load. The effect thereby obtained is same as with the synchronous movement of the thrust axis 4 and mast 2 according to FIG. 1.

The embodiment of the lift truck according to FIG. 2 permits an advantageous arrangement of the drive units 19 in the space 20 between the wheels 5 and mast base 14. The same region 20 can also be used for the foot space 21 of the lift truck drive. This utilization is permitted by the embodiment of the mast 2 as a vertical girder, and its arrangement approximately in vehicle centre permits and leads to short overall lengths of the lift truck.

FIG. 3 illustrates the side view of a lift truck which shows the opening 30 for the battery compartment 31. The displacement of the access to the battery compartment 31 to the side of a lift truck results in a side wall being eliminated as an essential support element of the lift truck frame 8. To compensate for the reduced stiffness of the frame 8, in the case of lift trucks according to the present invention a profile metal sheet 32 located outside the battery compartment 31 is provided, which reinforces the upward and forward facing walls 33 of the battery compartment 31. The channel 34 formed by the profile metal sheets 32 can also be used for laying lines (not shown).

FIGS. 4a and 4b illustrate essential components which are arranged within the individual mast sections of a three-part mast. FIG. 4a shows elements of the innermost mast section, while FIG. 4b shows the arrangement of the elements in a partly extended mast, the walls of the individual sections being left out for the sake of clarity. In both figures, the inner section is indicated by the reference character 40, the centre section by 41, and the outer section by 42. In FIG. 4b, the staged cylinder 43 and the free-lift cylinder 44 can be recognised. The free stroke cylinder is extended so far that the free-lift chain 47, running over a pulley 45 on the piston 46 of the free-lift cylinder 44, has moved the load carrier to its highest possible position. In this position, the load carrier 3 strikes against the striker plate 48, and is locked firmly to the striker plate 48 by means of the locking lever 49. Details of this arrangement are shown in FIG. 6b.

FIG. 4a shows the inner section 40 on an enlarged scale, the load carrier 3 being shown in its lowest possible position. Part of the staged cylinder 43, the free-lift cylinder 44 and its downwardly facing piston 46 can be seen. The free-lift chain 47 is fixed with its first end 50 at the interior wall of the section 40, runs over the pulley 45 on piston 46, and from there to a further deflection element 51 above the cylinder bottoms 44′, 43′ of free-lift cylinder 44 and staged cylinder 43. It emerges from the inner section 40 and is finally fixed with its other end 52 on the load carrier 3. In the region 53 between free-lift chain 47 and striker plate 48, the hydraulic hoses (not shown) are led through section 40. In the position of the load carrier 3 shown here, the locking lever 49 assumes its starting position.

FIG. 5 shows the cross-section through a three-part mast. It show the individual hollow profiles arranged telescopically one inside the other, of which profile 60 forms the inner section 40, profile 61 forms the centre section 41, and profile 62 forms the outer section 42. In the present embodiment, the profiles of each section are welded together from individual rolled profiles. As can be seen from FIG. 5, the most inward lying section 40 is welded together from two profiles 61′, 61″ and 62′, 62″ lying on the mast sides and a transverse plate in each case 61a, 61b and 62a, 62b′ arranged in the travel direction and counter travel direction. All profiles 60-62 are designed so as to be closed in the azimuthal direction, as a result of which a high torsional and flexural stiffness of the mast is achieved.

The rails 64, 64′ and 65, 65′ arranged symmetrically about the centre plane 63 serve for mutual guidance of the individual sections. Into the latter there engage the guide rollers (not shown) mounted on the respective opposition section. For fixing the load carrier to the mast, further guide rails 66, 66′ are provided on the outside of the outer section 42, in which the guide rollers (not shown) of the load carrier engage. As can be seen from the figure, the guide rails are an integral part of the profile, they also contribute to the flexural and torsional stiffness of the profile.

The proposed embodiment of the hollow profiles leads to the formation of cavities 67, 68 in the innermost of the inner sections 40. These inner spaces extend over the entire length of the section and are provided for receiving components for carrying out the upward and downward movement of the load carrier. In the profile according to FIG. 5, the cavity 67, facing the load side is provided for the staged cylinder 43 and the cavity 68, facing away from the load is provided for receiving the free-lift cylinder 44. In the present embodiment, in an advantageous manner, the cavity 67 is itself advantageously used as one of the cylinders of the staged cylinder.

FIGS. 6a and 6b shows details for the embodiment of the upper end of the inner section 40, wherein FIG. 6a shows the state without, and FIG. 6b the state with coupled load carrier. The striker plate 48, the locking lever 49 and the load carrier 3 can be seen. The striker plate 48 meets the function, in the event of the lift height of the load carrier extending above the height of the first section 42, of limiting the path of the load carrier 3, and creating a fixed coupling of the load carrier to the inner section 40. The striker plate 48 is correspondingly equipped with receptacles 69, in which, after the load carrier has struck against the striker plate, counter receptacles 70 formed on the load carrier 3 engage. In this operation, the locking lever 49 changes from the stationary position shown in FIG. 6a to the position according to FIG. 6b, and to lock the load carrier 3 by friction to the striker plate 48. The load carrier coupled to the striker plate is supported by means of the rollers 71, which are mounted on the inner section 40 and grip over the load carrier 3 from outside.

The change of the locking lever from the first to the second position is controlled by means of stop 72 (concealed in FIG. 6a) on the first section 42, against which the locking lever 49 bears at its upper end 73. With an upward movement of the load carrier 3, after it has struck against the striker plate 48, the innermost section 40, including the locking lever 49, is raised, while the aforementioned stop 72 remains stationary in the first section 42. By this means, the locking lever 49 of the stop is “withdrawn”, so that it changes to the second position according to FIG. 6b.

The embodiment shown above also has a catch device, which, in the event of incorrect fixing of the load carrier 3 against the striker plate 49, prevents extension of all inner section. This catch device is formed by the locking lever 49, its section 74 and the bolt 75 fastened on the outer section 42. During extension of the innermost section 40 at a position of the locking lever 49 in the first position shown according to FIG. 6a, that is to say the position in which the load carrier 3 was not locked, causes the notch 74 of the lever to run against the bolt 75 of the first section 42, and thereby blocks a further extension of the innermost section 40 relative to the first 42. The faultless change of the load carrier from the first section 42 to the innermost 40 thus forms the prerequisite for permitting the inner sections 42, 41 to be extended.

1-52. (canceled)

53. A lift truck, comprising:
a frame;
wheels fixed onto said frame;
a lifting mechanism having a mast, said mast comprising at least one mast section fixed onto said frame and having a non-circular hollow profile closed in its azimuthal direction;
a load carrier fixed to said lifting mechanism and being vertically movable; and,
means for vertically moving said load carrier.

54. The lift truck according to claim 53, wherein said non-circular hollow profile of said at least one mast section is symmetrical about a center plane containing a longitudinal axis of said mast and oriented in a longitudinal direction of said lift truck.

55. The lift truck according to claim 53, wherein said at least one mast section is a plurality of mask sections with mast sections of said plurality of mask sections being arranged within a first mast section.

56. The lift truck according to claim 55, further comprising a staged cylinder having a plurality of cylinders moving telescopically one cylinder inside another cylinder for extending and retracting said plurality of mask sections of said lifting mechanism.

57. The lift truck according to claim 56, further comprising guide rollers for said load carrier, wherein one mast section of said plurality of mast sections is an outer mask section having on its outer surface two guide rails arranged in a longitudinal direction of said mast and symmetrically about a center plane containing a longitudinal axis of said mast and oriented in a longitudinal direction of said lift truck, for receiving said guide rollers of said load carrier.

58. The lift truck according to claim 55, wherein said first mask section is fixed onto said frame at a first articulation point being a lower articulation point lying in a region of a base of said mast and a second articulation point being an upper deflection point lying a region between said base of said mast, said first mast section being pivotable in said first articulation point or said second articulation point about a horizontal axis lying perpendicular to a longitudinal direction of said lift truck, and further including means for pivoting having at least one hydraulic tilt cylinder arranged between said frame and one said articulation point in which said first mast section is not pivotable.

59. The lift truck according to claim 58, wherein said pivoting occurs about said upper deflection point and said at least one hydraulic tilt cylinder is fixed at said lower articulation point.

60. The lift truck according to claim 53, wherein said mast in a longitudinal direction of said lift truck is arranged between said wheels and a load.

61. The lift truck according to claim 53, wherein said wheels close to a load have a track width that is greater than a narrow side of a euro-pallet and greater than a width of said load carrier in a direction transverse to a longitudinal direction of said lift truck.

62. The lift truck according to claim 53, wherein said frame comprises a frame part displaceable in a longitudinal direction of said lift truck and means for displacing said frame part including a thrust-axis cylinder arranged between said frame and said frame part.

63. The lift truck according to claim 62, wherein during a lifting of said load carrier beyond a level of said wheels, a displacement of said frame part in a direction of a load and before a lowering of said load carrier below the level of said wheels, a further displacement takes place in a direction opposite to said longitudinal direction of said lift truck.

64. The lift truck according to claim 53, wherein said wheels proximate a load on said mast are fixed in a region of a base of said mast, said wheels being pivotable with said mast about an articulation point of said mast.

65. The lift truck according to claim 64, further comprising drive nuts arranged in a space between said wheels and said base of said mast.

66. The lift truck according to claim 53, wherein said non-circular hollow profile of said at least one mast section is a single-part profile.

67. The lift truck according to claim 53, wherein said non-circular hollow profile of said at least one mast section is comprised of individual rolled profiles welded together.

68. The lift truck according to claim 53, wherein said mast comprises two mast sections adjacent one another in a radial direction with a first mast section of said two mast sections being an inner mast section and a second mast section of said two mast sections being an outer mast section.

69. The lift truck according to claim 68, wherein said first mast section and said second mast section, upon reaching a fully extended position and a fully retracted position, each run up against an end position damper.

70. The lift truck according to claim 68, wherein said first mast section and said second mast section are extendable in a direction facing a base of said mast.

71. The lift truck according to claim 53, wherein said at least one mast section is a plurality of mast sections with one mast section being an innermost mast section and having at least one cavity extending of a length of said innermost mast section, said at least one cavity being provided for receiving components for executing vertical movement of said load carrier.

72. The lift truck according to claim 53, wherein said at least one mast section of said mast comprises an outer section, a center section and an inner section.

73. The lift truck according to claim 72, wherein said mast has an overall height, with said outer section, said center section and said inner section all in a retracted position, that is lower than an eye lever for a driver of said lift truck.

74. The lift truck according to claim 73, wherein said mast includes additional sections, in addition to said center section, between said outer section and said inner section.

75. The lift truck according to claim 53, wherein said at least one mast section of said mast comprises at least an inner section and an outer section with a striker plate fixed on said outer section, said load carrier striking against said striker plate when a lift height beyond a length of said inner section is reached.

76. The lift truck according to claim 75, wherein said load carrier, when striking against said striker plate, runs against an end-position damper.

77. The lift truck according to claim 75, wherein said striker plate includes receptacles into which counter-receptacles provided on said load carrier interlock.

78. The lift truck according to claim 53, wherein said at least one mast section of said mast comprises at least an inner section and an outer section, and further comprising means for frictional coupling of said load carrier to said outer section of said mast.

79. The lift truck according to claim 53, wherein said at least one mast section of said mast comprises at least an inner section and an outer section, and further comprising a catch device, so that in the event of an incorrect fixing of said load carrier at an upper end of said outer section, said catch device prevents an extension of said outer section.

80. The lift truck according to claim 79, wherein said catch device comprises a locking lever and a bolt fastened onto said inner section of said mast with a stop formed on said catch lever.

81. The lift truck according to claim 53, wherein said lift truck is a high-level picker.

82. The lift truck according to claim 53, further comprising a driver's seat within said frame oriented crosswise to a direction of travel.

83. The lift truck according to claim 53, wherein said at least one mast section is a plurality of mask sections with mast sections of said plurality of mask sections with a one mast section of said plurality of mask section being a first mast section being fixed to said frame and made of a non-circular hollow profile and closed in its azimuthal direction, and further mast sections of said plurality of mast sections each having a non-circular hollow profile that is closed in its azimuthal direction in a portion of a length of said further mast sections.

84. The lift truck according to claim 83, wherein said non-circular hollow profile of said first mast section and said non-circular hollow profile of said further mast sections are each symmetrical about a center plane containing a longitudinal axis of said mast and oriented in a longitudinal direction of said lift truck.

85. The lift truck according to claim 83, further comprising a staged cylinder having a plurality of cylinders moving telescopically one cylinder inside another cylinder for extending and retracting said plurality of mask sections of said lifting mechanism.

86. The lift truck according to claim 83, wherein said first mask section is fixed onto said frame at a first articulation point being a lower articulation point lying in a region of a base of said mast and a second articulation point being an upper deflection point lying a region between said base of said mast, said first mast section being pivotable in said first articulation point or said second articulation point about a horizontal axis lying perpendicular to a longitudinal direction of said lift truck, and further including means for pivoting having at least one hydraulic tilt cylinder arranged between said frame and one said articulation point in which said first mast section is not pivotable.

87. The lift truck according to claim 86, wherein said pivoting occurs about said upper deflection point and said at least one hydraulic tilt cylinder is fixed at said lower articulation point.
